(19) United States
(12) Patent Application Publication
(10) Pub. No.: US 2025/0371184 A1
(43) Pub. Date: Dec. 4, 2025

(54) SYSTEMS, METHODS, AND DEVICES FOR PROTECTING DATA IN STORAGE NETWORKS

(71) Applicant: Samsung Electronics Co., Ltd., Suwon-si (KR)

(72) Inventors: Eric Arden HIBBARD, Sunnyvale, CA (US); Michael ALLISON, Prospect, CO (US); Daniel Lee HELMICK, Erie, CO (US); David Scott MCINTYRE, Saratoga, CA (US); Young Bin PAIK, San Jose, CA (US)

(21) Appl. No.: 19/224,707

(22) Filed: May 30, 2025

Related U.S. Application Data
(60) Provisional application No. 63/653,963, filed on May 30, 2024.

(51) Int. Cl. G06F 21/62

(52) U.S. Cl. CPC G06F 21/6218

(57) ABSTRACT

An apparatus may include a storage medium, at least one communication interface configured to receive storage data, and at least one control circuit configured to perform one or more operations including transferring, using the at least one communication interface, protection information for the storage data, and storing, in the storage medium, based on the protection information, the storage data. The transferring the protection information may include receiving, using the at least one communication interface, alert information. The at least one control circuit may be further configured to perform an operation including detecting a data protection condition, and the transferring the protection information may include sending, using the at least one communication interface, based on the detecting, alert information. The at least one control circuit may be further configured to perform, based on the protection information, a data protection operation. The data protection operation may include a data lock operation.

### REFERENCE TO RELATED APPLICATION

This application claims priority to, and the benefit of, U.S. Provisional Patent Application Ser. No. 63/653,963 filed May 30, 2024 which is incorporated by reference.

### TECHNICAL FIELD

This disclosure relates generally to memory usage, and more specifically to systems, methods, and apparatus for protecting data in storage networks.

### BACKGROUND

A storage system may implement a data protection scheme to prevent data loss due to an attack that may destroy data or render data unusable. For example, a storage system may maintain a backup copy of data to enable the data to be recovered in the event of a ransomware attack that may encrypt the data to make it unusable.

The above information disclosed in this Background section is only for enhancement of understanding of the background of the inventive principles and therefore it may contain information that does not constitute prior art.

### SUMMARY

An apparatus may include a storage medium, at least one communication interface configured to receive storage data, and at least one control circuit configured to perform one or more operations including transferring, using the at least one communication interface, protection information for the storage data, and storing, in the storage medium, based on the protection information, the storage data. The transferring the protection information may include receiving, using the at least one communication interface, alert information. The at least one control circuit may be further configured to perform an operation including detecting a data protection condition, and the transferring the protection information may include sending, using the at least one communication interface, based on the detecting, alert information. The at least one control circuit may be further configured to perform, based on the protection information, a data protection operation. The data protection operation may include a data lock operation. The data protection operation may include a data hold operation. The data protection operation may include a backup operation. The data protection operation may be based on a policy. The at least one control circuit may be further configured to perform, using the storage data, an analysis operation. The at least one control circuit may be further configured to manage, based on the analysis operation, at least a portion of the storage medium.

An apparatus may include a device including at least one communication interface configured to use a first data path and a second data path, and a control circuit configured to transfer, using the first data path, storage data, and transfer, using the second data path, protection information for the storage data. The protection information may include a copy of at least a portion of the storage data. The protection information may include alert information. The control circuit may be further configured to receive, using the second data path, recovery information.

A method may include receiving, at a storage network, storage data, wherein the storage network may include a network fabric, transferring, to a data protection client, using the network fabric, the storage data, transferring, to a data protection node, using the network fabric, a copy of at least a portion of the storage data, and transferring, using the network fabric, alert information for the storage data. The method may further include performing, by the data protection node, based on the alert information, a data protection operation. The alert information may be transferred to the data protection node. The alert information may be transferred from the data protection node. The method may further include detecting, by the data protection node, a data protection condition, wherein the alert information may be generated, based on the data protection condition, by the data protection node. The storage data may be transferred to the data protection client using a first path of the network fabric, and the copy of the at least a portion of the storage data may be transferred using a second path of the network fabric.

### BRIEF DESCRIPTION OF THE DRAWINGS

The figures are not necessarily drawn to scale and elements of similar structures or functions may generally be represented by reference indicators ending in, and/or containing, the same digits, letters, and/or the like, for illustrative purposes throughout the figures. The figures are only intended to facilitate the description of the various embodiments described herein. The figures do not describe every aspect of the teachings disclosed herein and do not limit the scope of the claims. To prevent the drawings from becoming obscured, not all of the components, connections, and the like may be shown, and not all of the components may have reference numbers. However, patterns of component configurations may be readily apparent from the drawings. The accompanying drawings, together with the specification, illustrate example embodiments of the present disclosure, and, together with the description, serve to explain the principles of the present disclosure.

FIG. 1 illustrates an embodiment of a storage system architecture with a data protection scheme in accordance with example embodiments of the disclosure.

FIG. 2 illustrates an embodiment of a client device in accordance with example embodiments of the disclosure.

FIG. 3 illustrates an embodiment of a data protection node in accordance with example embodiments of the disclosure.

FIG. 4 illustrates an example embodiment of a storage system illustrating storage data interactions for a data protection node in accordance with example embodiments of the disclosure.

FIG. 5 illustrates an example embodiment of a storage data workflow for a data protection node in accordance with example embodiments of the disclosure.

FIG. 6 illustrates an example embodiment of a storage system illustrating alert interactions for a data protection node in accordance with example embodiments of the disclosure.

FIG. 7 illustrates an example embodiment of an alert workflow for a data protection node in accordance with example embodiments of the disclosure.

FIG. 8 illustrates an example embodiment of a storage system illustrating management interactions for a data protection node in accordance with example embodiments of the disclosure.

FIG. 9A illustrates first, second, and third portions of an example embodiment of a management workflow for a data protection node in accordance with example embodiments of the disclosure.

FIG. 9B illustrates a fourth portion of an example embodiment of a management workflow for a data protection node in accordance with example embodiments of the disclosure.

FIG. 10 illustrates an example embodiment of a data protection scheme for a storage system showing some additional possible implementation details for data flow, attack alerts, and/or management flow in accordance with example embodiments of the disclosure.

### DETAILED DESCRIPTION

Some storage systems may implement one or more data protection schemes to prevent data loss due to a computer network attack (which may be referred to as a cyberattack) such as a ransomware attack that may encrypt a user's data. For example, a storage system may periodically create a backup copy of data that may be used to recover data that has been encrypted by a ransomware attack. Some attacks, however, may be proceeded by reconnaissance and/or other preparations that may disable one or more protection schemes. For example, in preparation for an attack, an adversary may corrupt or disable backup copies of data, thereby preventing a storage system from recovering data that may be encrypted by a ransomware attack.

Some data protection schemes in accordance with example embodiments of the disclosure may operate in a manner that may reduce or eliminate the vulnerability of the data protection scheme to an attack. For example, a data protection scheme may communicate using a storage network that may use one or more protocols, interfaces, links, and/or the like, that may not be commonly used for public-facing (e.g., internet) connections. As another example, a data protection scheme may use a storage network having a first type of data path for storage data (e.g., production data) and a second type of data path for protection information (e.g., alerts, backup copies of data, authentication, and/or the like). In some embodiments, the second type of data path may not be accessible and/or visible to an attacker, a user of the storage system, and/or other entities that may pose a security risk for reconnaissance or attack.

Additionally, or alternatively, a data protection scheme in accordance with example embodiments of the disclosure may include one or more components that may be connected to a storage network to receive replicated data and/or implement a network-based attack alert mechanism. For example, a data protection node connected to a storage network may include storage space configured to maintain one or more replicas of data from one or more clients connected to the storage network. A data protection node may implement one or more features such as storage (e.g., production) data flow management, data processing, data analytics, potential threat detection, data recovery, and/or the like.

As another example, a network-based threat (e.g., attack) detection and/or alert mechanism may be implemented by one or more data protection nodes, clients, security hosts, management hosts, and/or the like, connected to a storage network. Potential threats may be detected at one or more components (e.g., any component) connected to a storage network and/or corresponding alerts may be transmitted to one or more components (e.g., any component) connected to the storage network. In some embodiments, one type of component (e.g., a security server) may detect and/or send an alert to other components based on potential threats it may learn about from outside the storage network, whereas other types of components (e.g., a data protection node, a client, and/or the like) may detect and/or send an alert to other components based on potential threats they may learn about from within the storage network (e.g., based on an analysis of processing and/or storage activity).

Some additional aspects of the disclosure relate to data protection policies, actions, and/or the like, that may be implemented by one or more components connected to a storage network. For example, a data protection node or other component may implement one or more policies to identify an urgency of a data protection condition (e.g., a potential threat), identify a scope of the condition, identify one or more protective actions, and/or issue one or more security alerts, commands, and/or the like. As a further example, a data protection node or other component may invoke one or more data protection operations such as immutability (e.g., write lock data), backup (e.g., store an archival copy of data), retention hold (e.g., maintain a backup copy of data based on a retention policy), and/or the like.

This disclosure encompasses numerous aspects relating to memory usage based on data access characteristics and memory endurance characteristics. The aspects disclosed herein may have independent utility and may be embodied individually, and not every embodiment may utilize every aspect. Moreover, the aspects may also be embodied in various combinations, some of which may amplify some benefits of the individual aspects in a synergistic manner.

For purposes of illustration, some embodiments may be described in the context of some specific implementation. However, the aspects of the disclosure are not limited to these or any other implementation details.

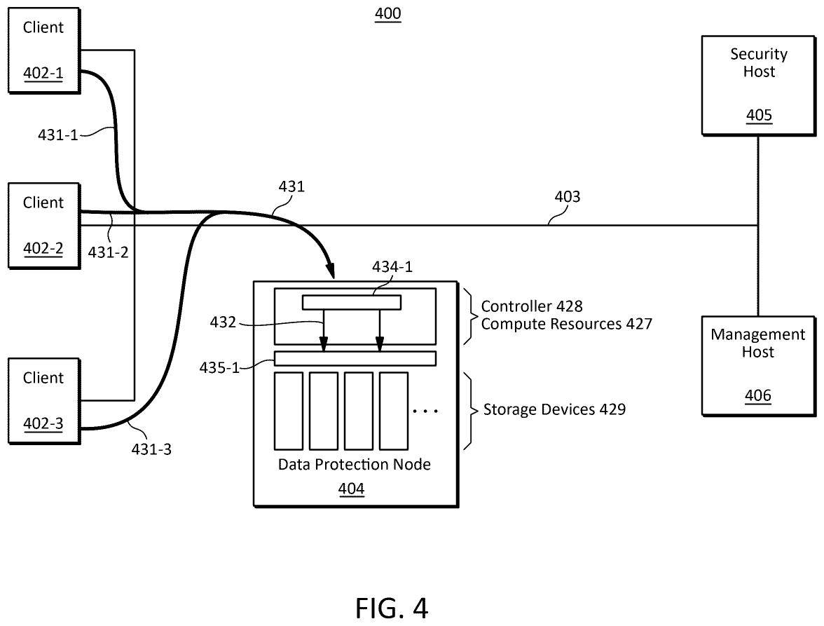

In some embodiments described herein, reference indicators having a base portion and a suffix portion may be referred to collectively and/or individually by the base portion. In some example embodiments described herein, multiple figures having the same numbers with different letter suffixes may be referred to collectively and/or individually by the number. For example, referring to FIG. 4, clients 402-1, 402-2, and/or 402-3 may be referred to collectively and/or individually as a client or clients 402.

In some example embodiments described herein, single or multiple instances of an element may be referred to collectively and/or individually as “a” and/or “the.” For example, one or more devices may be referred to as the device or a device.

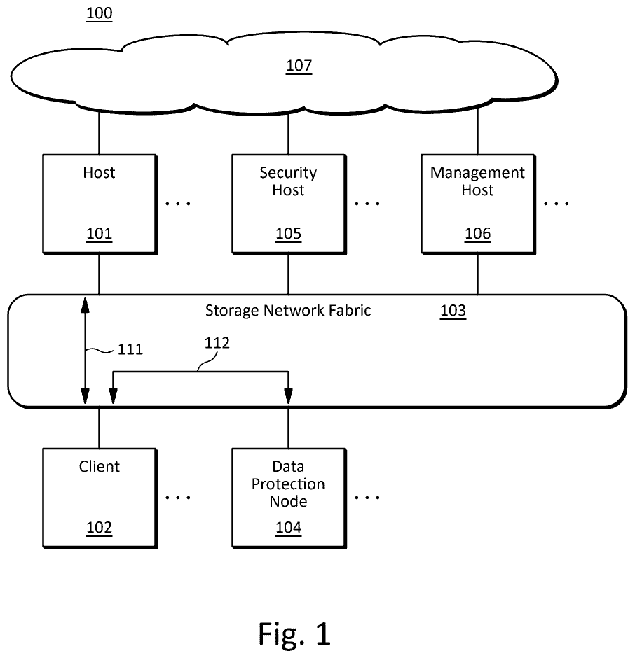

FIG. 1 illustrates an embodiment of a storage system architecture with a data protection scheme in accordance with example embodiments of the disclosure. The storage system 100 may include one or more hosts 101 (which may be referred to as data hosts, storage hosts, and/or production hosts) connected to one or more clients 102 (which may be referred to as data clients, data protection clients (DPCs), production clients, and/or cyber recovery clients (CRCs)) using a storage network fabric 103. The storage system 100 may also include one or more data protection nodes (DPNs) 104 (which may be referred to as data protection vaults and/or cyber recovery vaults (CRVs)) connected to the storage network fabric 103. The storage system 100 may also include one or more security hosts 105 and/or one or more management hosts 106 that may be connected to the storage network fabric 103. In some embodiments, one or more of hosts 101, 105, and/or 106 may be connected to a network 107 which may include one or more publicly accessible networks or network of networks such as the internet.

One or more (e.g., any) of hosts 101, 105, and/or 106 may be implemented with any component or combination of components that may utilize, and/or implement, one or more features of the system 100 including a client 102, a data protection node 104, and/or the like. For example, a host may be implemented with one or more of a server (e.g., a compute server, a storage server, and/or the like), a storage node, a compute node, a central processing unit (CPU), a workstation, a personal computer, a tablet computer, a smartphone, and/or the like, or multiples and/or combinations thereof.

A host 101 may operate as a server, gateway, router, user interface, and/or the like, for a user to transfer storage data (e.g., production data) to one or more clients 102. For example, in some embodiments, a host 101 may receive production data from network 107 and transfer the production data to a client 102 using a first data path (e.g., a production data path) 111 through storage network fabric 103.

A security host 105 may include functionality to detect a data protection condition (e.g., a ransomware or other attack), transmit and/or receive an alert (e.g., a notification of an attack) to and/or from one or more other components (e.g., another security host 105, a management host 106, a client 102, a data protection node 104, and/or the like). A security host 105 may detect a data protection condition internally (e.g., by monitoring one or more other components in system 100) and/or externally (e.g., by learning about potential attacks from a managed security service or other source of information about threats through the internet). In some embodiments, a security host 105 may include the ability to issue a storage network-based attack alert to one or more data protection nodes 104 independently of one or more clients 102 which, depending on the implementation details, may enable one or more data protection operations to be performed without visibility to a user storing production data using a host 101 and/or a client 102.

A management host 106 may include functionality to configure and/or manage one or more (e.g., any or all) of the components of system 100 to implement a data protection scheme in accordance with example embodiments of the disclosure. For example, a management host 106 may configure communications and/or interactions between components, establish policies and/or operations for components, and/or the like.

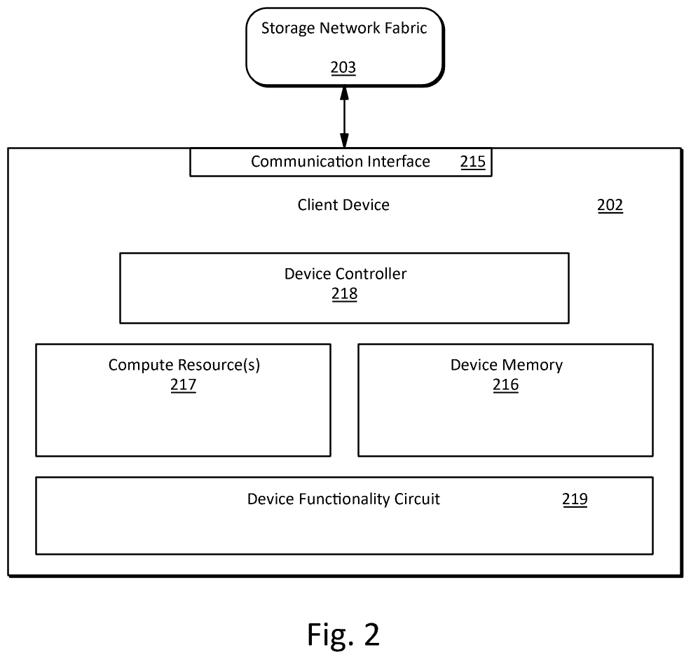

A client 102 may be implemented with one or more devices such as storage devices, computational devices, memory expanders, and/or the like, having data storage media as described in more detail below with respect to FIG. 2. In some embodiments, a client 102 may have compute resources (e.g., a computational storage device) that may enable the client to replicate data (e.g., on a configurable interval) and send the replicated data to a data protection node 104 (e.g., using a second data path 112 of storage network fabric 103) in such a manner that interactions between the client 102 and the data protection node 104 may not be visible to one or more hosts interacting with the client 102. In some embodiments, upon detection and/or notification of a potential attack, a client 102 may issue a storage network-based attack alert to one or more data protection nodes 104, security host 105, and/or the like. In some embodiments, a client 102 may recover, using storage network fabric 103, replicated data that it previously sent to one or more data protection nodes 104, for example, to replace data that has been encrypted or destroyed by an attack.

Storage network fabric 103 may be implemented with any communication medium, interface, network, interconnect, protocol, and/or the like, for a storage system, such as Serial Advanced Technology Attachment (SATA), Small Computer Systems Interface (SCSI), Serial Attached SCSI (SAS). Peripheral Component Interconnect Express (PCIe), Nonvolatile Memory Express (NVMe), NVMe over Fabric (NVMe-oF), Fibre Channel, InfiniBand, and/or the like, or any combination or multiples thereof. In some embodiments, storage network fabric 103 may include one or more switches, hubs, nodes, routers, and/or the like.

In some embodiments, one or more portions of storage network fabric 103 may be implemented with a secondary network such as a management interface (e.g., NVMe Management Interface (NVMe-MI)) which, depending on the implementation details, may reduce the detectability of communications by an attacker. In some embodiments, one or more portions of storage network fabric 103 may be implemented with relatively high-speed storage networking apparatus and/or techniques to enable relatively fast recovery from an attack by transferring one or more data replicas back to the original source clients at relatively high transfer rates.

Although, in some embodiments, storage network fabric 103 may be implemented with one or more of a communication medium, interface, network, interconnect, protocol, and/or the like, that may be adapted for a storage system, in some other embodiments, storage network fabric 103 may be implemented alternatively or additionally with any other communication medium, interface, network, interconnect, protocol, and/or the like, such as Compute Express Link (CXL), CXL.mem, CXL.cache, CXL.io, Gen-Z, Open Coherent Accelerator Processor Interface (OpenCAPI), Cache Coherent Interconnect for Accelerators (CCIX), Advanced eXtensible Interface (AXI), Direct Memory Access (DMA), Remote DMA (RDMA), RDMA over Converged Ethernet (ROCE), Advanced Message Queuing Protocol (AMQP), Ethernet, Transmission Control Protocol/Internet Protocol (TCP/IP), and/or the like.

A data protection node 104 may be implemented with one or more of a server (e.g., a compute server, a storage server, and/or the like), a storage node, a compute node, a CPU, a workstation, a personal computer, and/or the like, or multiples and/or combinations thereof, having data storage media (e.g., in one or more storage devices) to store replicated and/or other data from one or more clients 102, hosts 101, 105, and/or 106, and/or the like.

In some embodiments, a data protection node 104 may include management functionality that may enable the data protection node 104 to perform any number of the following functions: establishing and maintaining trust relationships with other storage network entities (which may be referred to as trusted entities); managing replicated data from one or more (e.g., each) trusted entities (e.g., number of copies, age, retention time, and/or the like); receiving storage network-based attack alerts from trusted entities (e.g., from a client 102, a host 101 and/or a security host 105); detecting and/or reporting, to other trusted entities, abnormal data and/or usage patterns which may indicate a potential attack; and/or manage one or more clients 102 and/or configurations within a data protection node 104.

Additionally, or alternatively, in some embodiments, a data protection node 104 may include data protection functionality that may enable the data protection node 104 to perform any number of the following functions: encrypt some or all production data and/or protection information (e.g., copies of production data) to reduce or prevent data leaks due to the removal of one or more individual components of system 100 such as one or more clients 102; transition one or more (e.g., all) storage media (e.g., storage devices) into a data protection (e.g., immutable) mode such as a write lock mode to prevent an attack from overwriting and/or sanitizing data, a data hold mode to prevent one or more backup copies of replicated data from being deleted, and/or a backup mode to create one or more backup copies of replicated data. In some embodiments, a data protection mode may be maintained, for example, until a system and/or component reset.

In some embodiments, a data protection node 104 may use a command and/or feature lockdown to implement some or all of the data protection features disclosed herein. For example, some embodiments may use NVMe command and/or feature lockdown functionality to disable one or more commands after an initial CRV setup and/or initialize phase (e.g., during deployment, configuration, and/or the like, of one or more clients 102 and/or other components. In some embodiments, one or more commands and/or features may be implemented with a permanent lock down which may be removed at reset, reboot, and/or the like.

Additionally, or alternatively, in some embodiments, a data protection node 104 may include data storage and/or recovery functionality that may enable the data protection node 104 to perform any number of the following functions: receive and/or store replicated data from one or more trusted storage network-based entities; and/or operate as a source of recovery data (e.g. for some or all data replicas) for a trusted data source (e.g., a client 102) which may involve ensuring that the data protection makes authorized data (e.g., only authorized data) to the trusted data source.

Depending on the implementation details, the storage system 100 illustrated in FIG. 1 may be configured to implement a storage network-based recovery platform that may receive and/or store replicated data from one or more components (e.g., clients 102, hosts 101, and/or the like), protect the replicated data when a potential or actual attack is detected and/or anticipated, and facilitate recovery of data from the recovery platform to an original source of the data (e.g., clients 102, hosts 101, and/or the like) after the attack is mitigated, concluded, and/or the like. In some embodiments, one or more of the data protection operations of a data protection node 104 and/or other components of storage system 100 may not be visible to a user, host 101, and/or the like, of storage system 100. Thus, a data protection node 104 and/or associated data transfers may be embedded in a storage network where it may be hidden and/or impervious to attacks.

In some embodiments, the use of one or more storage network communication medium, interface, network, interconnect, protocol, and/or the like may prevent one or more of the data protection operations from being visible to a user, host 101, and/or the like (which may be referred to as operating transparently to the user, host 101, and/or the like). Moreover, depending on the implementation details, a storage network communication medium, interface, network, interconnect, protocol, and/or the like may be inherently less susceptible to reconnaissance and/or attacks.

In some embodiments, using a second data path 112 (which may be separate and/or different from a production data path 111) to transfer copies of replicated data to and/or from a data protection node 104 may reduce or eliminate false positive detections and/or alerts. Additionally, or alternatively, transferring data protection information such as copies of replicated data using a data path 112 separate and/or different from a production data path 111 may reduce or eliminate the impact on production data transfers to and/or from storage at clients 102.

Additionally, or alternatively, the storage system 100 illustrated in FIG. 1 may be used to implement external detection and notification (e.g., by information received by a security host 105) and/or on-board analytics (e.g., by a security host 104 and/or a data protection node 104) provide early warnings of attacks. Depending on the implementation details, the storage system 100 may provide relatively fast, (e.g., near instantaneous) invocation of immutability measures (e.g., write locking) which may increase or maximize protection of data. Additionally, or alternatively, the storage system 100 may be configured to provide continuous data protection (CDP), for example, by creating, transferring, and/or storing multiple copies of replicated production data to enable relatively fast recovery from one or more of the previously stored replicas.

FIG. 2 illustrates an embodiment of a client device in accordance with example embodiments of the disclosure. The client device 202 illustrated in FIG. 2 may be used to implement, or be implemented with, any of the clients disclosed herein including a client 102 illustrated in FIG. 1.

Referring to FIG. 2, client device 202 may include one or more communication interfaces 215, memory 216 (some or all of which may be referred to as device memory), one or more compute resources 217 (which may also be referred to as computational resources), a device controller 218, and/or a device functionality circuit 219. The device controller 218 may control the overall operation of the client device 202 including any of the operations, features, and/or the like, described herein. For example, in some embodiments, the device controller 218 may parse, process, invoke, and/or the like, commands received from a host 101, 105, 106, a data protection node 104, and/or the like.

The device functionality circuit 219 may include any hardware to implement the primary function of the client device 202. For example, if the client device 202 is implemented as a storage device (e.g., a computational storage device), the device functionality circuit 219 may include storage media such as magnetic media (e.g., if the client device 202 is implemented as a hard disk drive (HDD) or a tape drive), solid state media (e.g., one or more flash memory devices), optical media, and/or the like. For instance, in some embodiments, a storage device may be implemented at least partially as a solid state drive (SSD) based on not-AND (NAND) flash memory, persistent memory (PMEM) such as cross-gridded nonvolatile memory, memory with bulk resistance change, phase change memory (PCM), or any combination thereof. In some embodiments, a client 202 may be implemented as a computational storage drive, a computational storage processor (CSP), and/or a computational storage array (CSA).

As another example, if the client device 202 is implemented as a network interface controller (NIC), the device functionality circuit 219 may include one or more modems, network interfaces, physical layers (PHYs), medium access control layers (MACs), and/or the like. As a further example, if the client device 202 is implemented as an accelerator, the device functionality circuit 219 may include one or more accelerator circuits, memory circuits, and/or the like.

Device controller 218 may be implemented with one or more circuits in any suitable form such as at least one processing circuit (e.g., processor), field programmable gate array (FPGA), application specific integrated circuit (ASIC), complex programmable logic device (CPLD), dedicated or shared portion of an integrated circuit, and/or the like. In an embodiment in which the client device 202 is implemented as a storage device, the device controller 218 may include a media translation layer such as a flash translation layer (FTL) for interfacing with one or more flash memory devices.

Compute resources 217 may be implemented with any component or combination of components that may perform operations on data that may be received, stored, and/or generated at the client device 202. Examples of compute engines may include combinational logic, sequential logic, timers, counters, registers, state machines, complex programmable logic devices (CPLDs), field programmable gate arrays (FPGAs), application specific integrated circuits (ASICs), embedded processors, microcontrollers, central processing units (CPUs) such as complex instruction set computer (CISC) processors (e.g., x86 processors) and/or a reduced instruction set computer (RISC) processors such as ARM processors, graphics processing units (GPUs), data processing units (DPUs), neural processing units (NPUs), tensor processing units (TPUs), and/or the like, that may execute instructions stored in any type of memory and/or implement any type of execution environment such as a container, a virtual machine, an operating system such as Linux, an Extended Berkeley Packet Filter (eBPF) environment, and/or the like, or a combination thereof.

The memory 216 may be used, for example, by one or more of the compute resources 217 to store input data, output data (e.g., computation results), intermediate data, transitional data, and/or the like. The memory 216 may be implemented, for example, with volatile memory such as dynamic random access memory (DRAM), static random access memory (SRAM), and/or the like, as well as any other type of memory such as nonvolatile memory.

In some embodiments, the memory 216 and/or compute resources 217 may include software, instructions, programs, code, and/or the like, that may be performed, executed, and/or the like, using one or more compute resources (e.g., hardware (HW) resources). Examples may include software implemented in any language such as assembly language, C, C++, and/or the like, binary code, FPGA code, one or more operating systems, kernels, environments such as eBPF, and/or the like. Software, instructions, programs, code, and/or the like, may be stored, for example, in a repository in memory 216 and/or compute resources 217. Software, instructions, programs, code, and/or the like, may be downloaded, uploaded, sideloaded, pre-installed, built-in, and/or the like, to the memory 216 and/or compute resources 217. In some embodiments, the client device 202 may receive one or more instructions, commands, and/or the like, to select, enable, activate, execute, and/or the like, software, instructions, programs, code, and/or the like. Examples of computational operations, functions, and/or the like, that may be implemented by the memory 216, compute resources 217, software, instructions, programs, code, and/or the like, may include any type of algorithm, data movement, data management, data selection, filtering, encryption and/or decryption, compression and/or decompression, checksum calculation, hash value calculation, cyclic redundancy check (CRC), weight calculations, activation function calculations, training, inference, classification, regression, and/or the like, for artificial intelligence (A/I), machine learning (ML), neural networks, and/or the like.

The one or more communication interfaces 215 at a client device 202 may implement one or more communication media, interfaces, networks, interconnects, protocols, and/or the like, used to implement storage network fabric 203. In some embodiments, the one or more communication interfaces 215 may implement, for example, a primary interface and a sideband (e.g., control) interface. Examples of interfaces may include NVMe, PCIe Vendor Defined Messaging (PCIe VDM), Management Component Transport Protocol (MCTP) over System Management Bus (SMBus), Inter-Integrated Circuit (I2C), Improved Inter-Integrated Circuit (I3C), MCTP over NVMe, and/or the like.

In some embodiments, one or more communication interfaces 215 may implement one or more PCIe links having any number of lanes (e.g., X1, X4, X8, X16, and/or the like). A protocol stack at client device 202 may include an interconnect (e.g., PCIe) layer and/or a device driver that may implement a storage protocol (e.g., an NVMe protocol) that may operate over the underlying PCIe protocol, transport layer, link layer, physical layer, and/or the like. The communication interface 215 and/or device controller 218 at client device 202 may include one or more storage protocol controllers (e.g., an NVMe controller) that may implement one or more storage protocol subsystems (e.g., NVMe subsystems) that may enable a host and a client device 202 to communicate using an NVMe protocol over a PCIe link.

A client device 202 may be implemented in any physical form factor. Examples of form factors may include a 3.5 inch, 2.5 inch, 1.8 inch, and/or the like, storage device (e.g., storage drive) form factor, M.2 device form factor, Enterprise and Data Center Standard Form Factor (EDSFF) (which may include, for example, E1.S, E1.L, E3.S, E3.L, E3.S 2T, E3.L 2T, and/or the like), add-in card (AIC) (e.g., a PCIe card (e.g., PCIe expansion card) form factor including half-height (HH), half-length (HL), half-height, half-length (HHHL), and/or the like), Next-generation Small Form Factor (NGSFF), NFl form factor, compact flash (CF) form factor, secure digital (SD) card form factor, Personal Computer Memory Card International Association (PCMCIA) device form factor, and/or the like, or a combination thereof. Any of the client devices disclosed herein may be connected to a system using one or more connectors such as SATA connectors. SCSI connectors, SAS connectors, M.2 connectors, EDSFF connectors (e.g., 1C, 2C, 4C, 4C+, and/or the like), U.2 connectors (which may also be referred to as SSD form factor (SSF) SFF-8639 connectors), U.3 connectors, PCIe connectors (e.g., card edge connectors), and/or the like.

In some embodiments, a client device 202 may be implemented with any device that may include, or have access to, memory, storage media, and/or the like, to store data that may be processed by one or more compute resources 217. Examples may include memory expansion and/or buffer devices such as CXL type 2 and/or CXL type 3 devices, as well as CXL type 1 devices that may include memory, storage media, and/or the like.

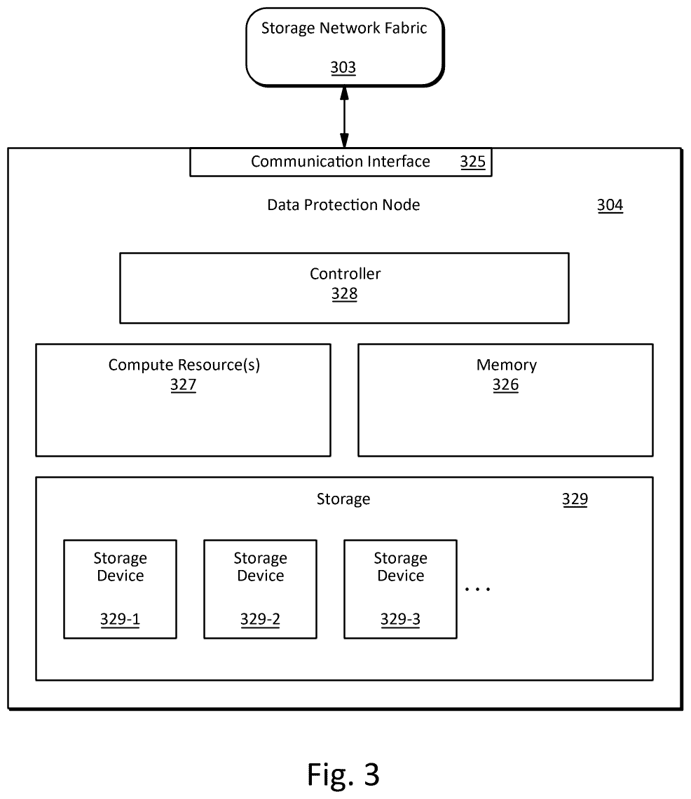

FIG. 3 illustrates an embodiment of a data protection node in accordance with example embodiments of the disclosure. The data protection node 304 illustrated in FIG. 3 may be used to implement, or be implemented with, any of the data protection nodes disclosed herein including a data protection node 104 illustrated in FIG. 1. The data protection node 304 illustrated in FIG. 3 may include one or more elements that may, in some aspects, be similar to one or more elements in the embodiment illustrated in FIG. 2 in which similar elements may be indicated by reference numbers ending in, and/or containing, the same digits, letters, and/or the like.

Referring to FIG. 3, data protection node 304 may include one or more communication interfaces 325, memory 326, one or more compute resources 327 (which may also be referred to as computational resources), a controller 328, and storage 329 which may include, for example, one or more storage devices 329-1, 329-2, . . . . Controller 328 may control the overall operation of the data protection node 304 including any of the management, data protection, and/or data recovery features disclosed herein.

The one or more communication interfaces 325 may implement one or more communication media, interfaces, networks, interconnects, protocols, and/or the like, used to implement storage network fabric 303. In some embodiments, the one or more communication interfaces 325 may implement, for example, a primary interface and a sideband (e.g., control) interface. Examples of interfaces may include NVMe, PCIe Vendor Defined Messaging (PCIe VDM), Management Component Transport Protocol (MCTP) over System Management Bus (SMBus), Inter-Integrated Circuit (I2C), Improved Inter-Integrated Circuit (I3C), MCTP over NVMe, and/or the like.

Data protection node 304 may be implemented, for example, with one or more of a server (e.g., a compute server, a storage server, and/or the like) located in a server chassis, a server rack, a storage node, a compute node, a CPU, a workstation, a personal computer, and/or the like, or multiples and/or combinations thereof.

For purposes of illustration, some example embodiments of storage systems and/or methods may be described below in the context of a storage system having some specific implementation details such as storage network fabric topology, types and/or numbers of components, operations, and/or the like. Aspects of the disclosure, however, are not limited to the illustrated details and may be implemented in an unlimited number of other configurations.

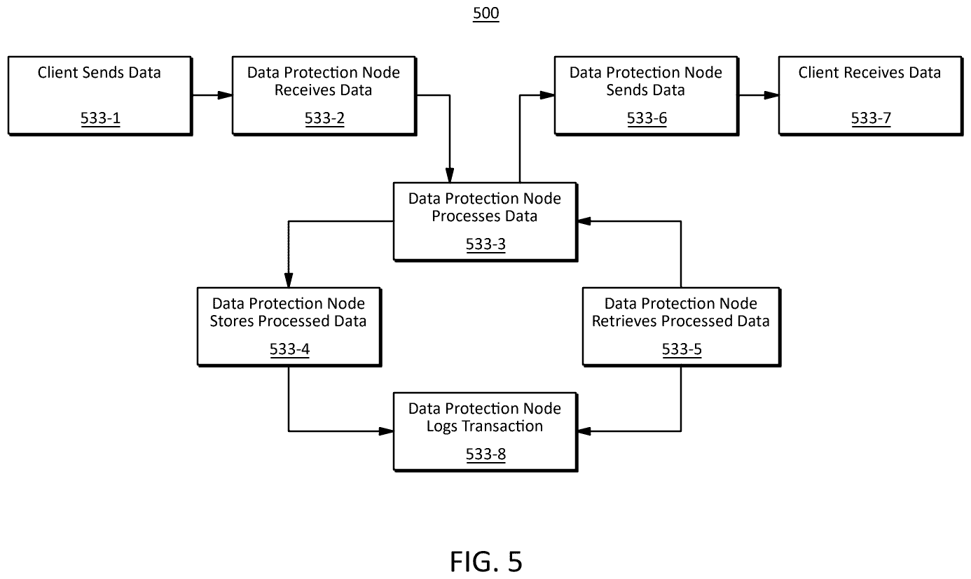

FIG. 4 illustrates an example embodiment of a storage system illustrating storage data interactions for a data protection node in accordance with example embodiments of the disclosure. FIG. 5 illustrates an example embodiment of a storage data workflow for a data protection node in accordance with example embodiments of the disclosure. The workflow 500 illustrated in FIG. 5 may be implemented, for example, with the storage system 400 illustrated in FIG. 4. However, the workflow 500 is not limited to any details of the storage system 400, and the storage system 400 is not limited to any of the details of the workflow 500.

The storage system 400 illustrated in FIG. 4 may include one or more elements that may, in some aspects, be similar to one or more elements in the embodiment illustrated in other figures in which similar elements may be indicated by reference numbers ending in, and/or containing, the same digits, letters, and/or the like.

Referring to FIG. 4 and FIG. 5, storage system 400 may include one or more clients 402-1, 402-2, and/or 402-3, a data protection node 404, a security host 405, a management host 406 and/or storage network fabric 403.

At operation 533-1 a client 402-1 may send protection information in the form of a replica of production data to data protection node 404 as shown by arrow 431-1. At operation 533-2, data protection node 404 may receive the protection information as shown by replica of production data 434-1 at the controller 428. At operation 533-3, data protection node 404 may process the replica of production data 434-1, for example, using controller 428 and/or compute resources 427.

Examples of processing operation 533-3 may include compression, encryption, analysis, and/or detection of a data protection condition (e.g., an attack). Examples of analysis and/or detection may include determining a compression rate or ratio for data sent to data protection node 404. Unencrypted data (e.g., clear text such as unencrypted email) may be compressed at a relatively high compression rate by a host, client 402, and/or data protection node 404. However, in some embodiments, and depending on the implementation details, encrypted data may be compressed at a relatively low compression rate (e.g., because the data may appear to be random to a compression algorithm).

Thus, a sudden reduction in compression rate (and/or increase in an amount of storage space) for replica data 434-1 sent to data protection node 404 may indicate that an attack is occurring. e.g., a host 401 and/or a client 402 has been taken over by ransomware software that may be encrypting production data that may be stored at, and/or passing through, a host 401 and/or a client 402, and/or the replica data 434-1 sent to data protection node 404. In such a situation, data protection node 404 may send an alert to one or more other components such as a host 401 and/or a client 402 as explained in more detail below. Additionally, or alternatively, in such a situation, data protection node 404 may perform a data protection operation such as write locking other data stored at data protection node 404, making a backup of other data stored at data protection node 404, and/or the like as explained in more detail below.

At operation 533-4, data protection node 404 may store the processed replica of production data shown as 435-1 in one or more storage devices 429 (provided the production data is not the subject of an attack).

At operation 533-5, data protection node 404 may retrieve the processed replica of production data 435-1 from one or more storage devices 429, for example, based on receiving a request or instruction to recover data for client 402-1. The data may need to be recovered, for example, if client 402-1 lost data due to an attack (e.g., a ransomware attack that encrypted data).

At operation 533-3 for a second pass, data protection node 404 may process the replica of production data 435-1, for example, to perform a complementary operation such as decompression if the data was compressed during the first pass through operation 533-3 and/or decryption if the data was encrypted during the first pass through operation 533-3 to restore the retrieved data to a form similar to, or the same as the replica of production data 435-1 it received from client 402-1. At operation 533-6, data protection node 404 may send the retrieved (and possibly restored) replica of production data 435-1 to client 402-1 using storage network fabric 403. At operation 533-7, client 402-1 may receive the retrieved (and possibly restored) replica of production data 435-1, for example, in the reverse direction of arrow 431-1.

Additionally, or alternatively, at operation 533-8, data protection node 404 may create and/or store one or more log entries for one or more transactions such as the storage, processing, and retrieval transaction described above. A log of transactions may be maintained and/or analyzed by one or more data protection nodes 404, one or more security hosts 105, and/or the like to provide after-the-fact and/or real-time information about one or more attacks. For example, information from a log may reveal when and/or where an attack began, the extent of an attack (e.g., how many components were affected, and for how long), whether an attack was real or a false positive, and/or the like. Additionally. or alternatively, a log may reveal that an attack was preceded (e.g., by several months) by surveillance malware that may have studied vulnerabilities in the storage system and/or performed preparations for an attack such as disrupting, corrupting, and/or disabling data protection techniques such as disabling backup operations, corrupting replicated data, disabling and/or defeating detection operations, and/or the like.

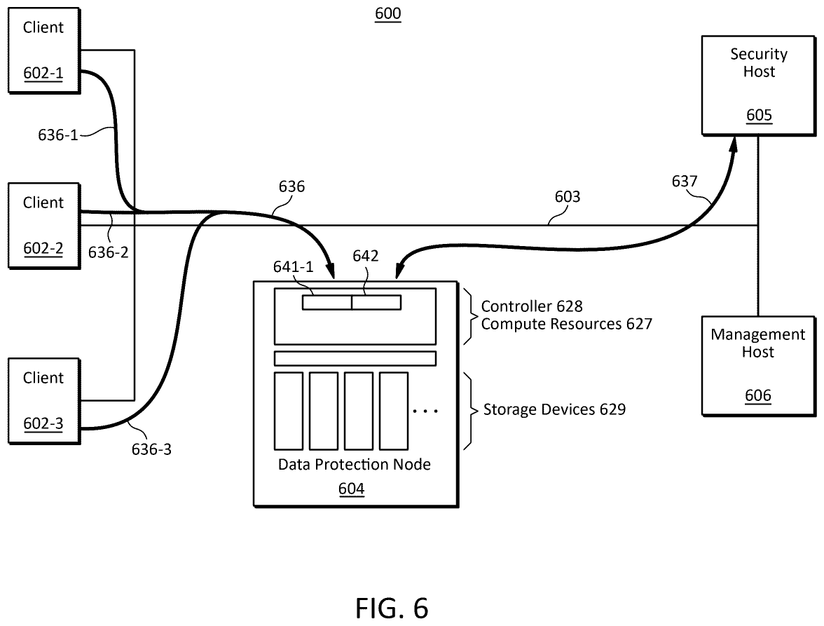

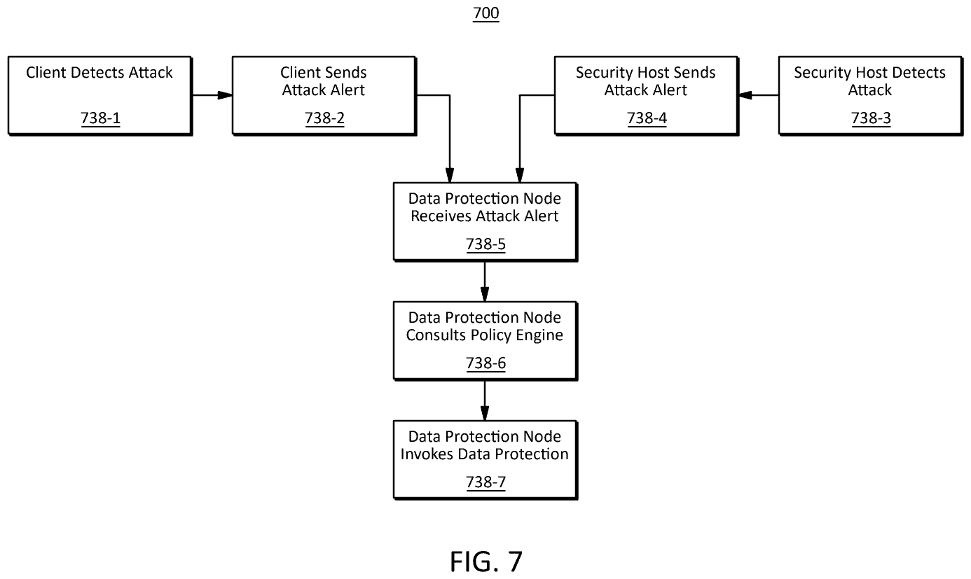

FIG. 6 illustrates an example embodiment of a storage system illustrating alert interactions for a data protection node in accordance with example embodiments of the disclosure. FIG. 7 illustrates an example embodiment of an alert workflow for a data protection node in accordance with example embodiments of the disclosure. The workflow 700 illustrated in FIG. 7 may be implemented, for example, with the storage system 600 illustrated in FIG. 6. However, the workflow 700 is not limited to any details of the storage system 600, and the storage system 600 is not limited to any of the details of the workflow 700.

The storage system 600 illustrated in FIG. 6 may include one or more elements that may, in some aspects, be similar to one or more elements in the embodiment illustrated in other figures in which similar elements may be indicated by reference numbers ending in, and/or containing, the same digits, letters, and/or the like.

Referring to FIG. 6 and FIG. 7, storage system 600 may include one or more clients 602-1, 602-2, and/or 602-3, a data protection node 604, a security host 605, a management host 606 and/or storage network fabric 603.

At operation 738-1, client 602-1 may detect an attack. At operation 738-2, client 602-1 may send an attack alert to data protection node 604 as illustrated by arrow 636-1. At operation 738-5, data protection node 604 may receive the alert 641-1. Additionally, or alternatively, at operation 738-3, security host 705 may detect an attack. At operation 738-4, security host 605 may send an attack alert to data protection node 604 as illustrated by arrow 637. At operation 738-5, data protection node 604 may receive the attack alert 642.

At operation 738-6, data protection node 604 may consult a policy (e.g., using a policy engine) to perform one or more operations relating to understanding, and/or planning a response to, the attack indicated by alert 641-1 and/or 642. An example of an operation may include determining an urgency of a response to the attack. For example, if client 602-1 is receiving and processing data from a host, and the host suddenly starts encrypting the data without advance notice, this may indicate an attack is occurring which may be an urgent alert, and client 602-1 may inform data protection node 604 (via alert 641-1) that data protection node 604 immediately perform a protective operation. Another example of an operation may include a scope of the attack (e.g., whether the attack is directed to the entire storage system 600 or a certain number of individual components. A further example of an operation may include identifying one or more protective actions such as write locking data, invoking a retention hold, performing a backup, and/or the like. An additional example of an operation may include issuing one or more security notifications (e.g., alerts) to one or more components, logging information about the attack and/or actions taken in response to the attack, and/or the like.

One or more of the protective actions may depend, however, on a policy for the specific data source. For example, if client 602-1 is storing data from a scientific experiment (e.g., data generated in real time from an experiment that may not be easily repeated), a write lock may not be a viable action, and thus, an alternative protection action may be selected.

At operation 738-7, data protection node 604 may perform one or more protective actions determined at operation 738-6. For example, data protection node 604 may invoke an immutability action (e.g., a write lock, disabling a sanitize operation, and/or the like), invoke a retention hold (e.g., to prevent older backup data from being deleted until the system 600 and/or an administrator may confirm that it is no longer needed), and/or performing a backup operation on data from a component such as client 602-1.

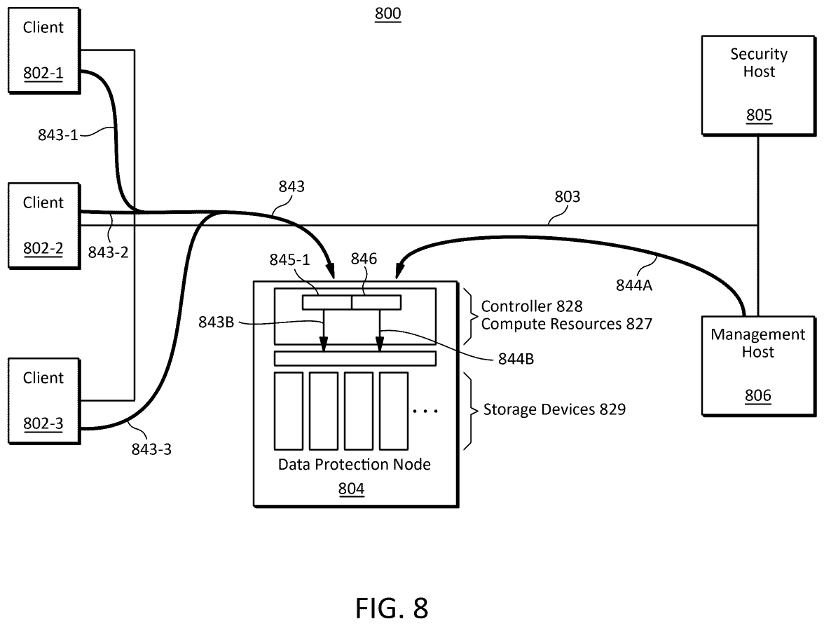

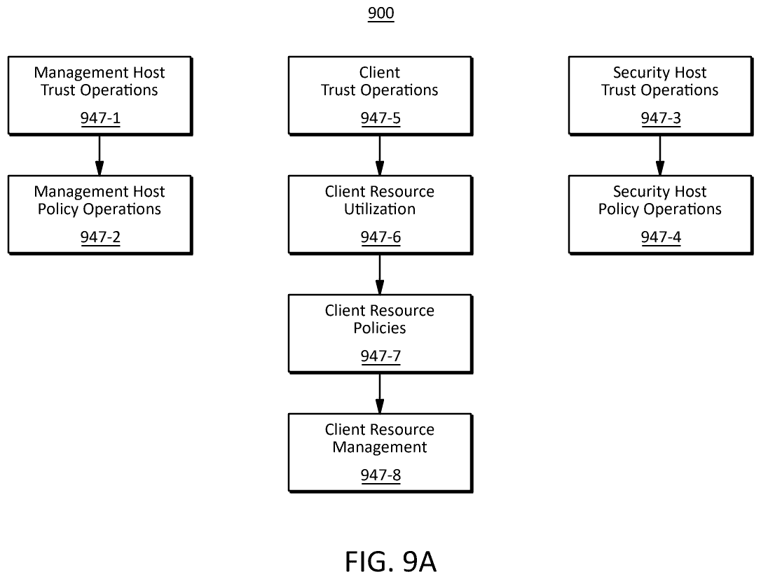

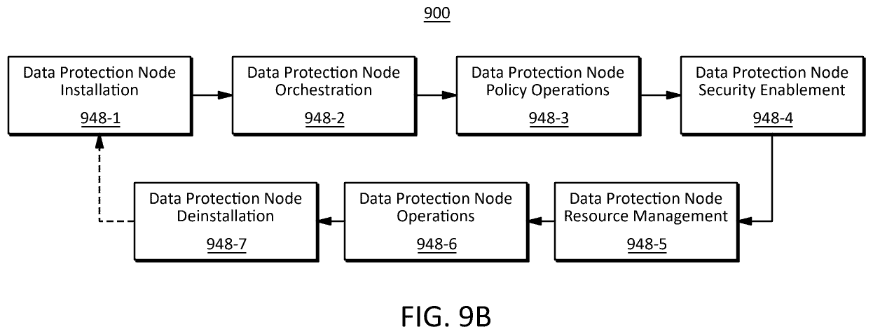

FIG. 8 illustrates an example embodiment of a storage system illustrating management interactions for a data protection node in accordance with example embodiments of the disclosure. FIG. 9A illustrates first, second, and third portions of an example embodiment of a management workflow for a data protection node in accordance with example embodiments of the disclosure. FIG. 9B illustrates a fourth portion of an example embodiment of a management workflow for a data protection node in accordance with example embodiments of the disclosure. The workflow 900 illustrated in FIG. 9 may be implemented, for example, with the storage system 800 illustrated in FIG. 8. However, the workflow 900 is not limited to any details of the storage system 800, and the storage system 800 is not limited to any of the details of the workflow 900.

The storage system 800 illustrated in FIG. 8 may include one or more elements that may, in some aspects, be similar to one or more elements in the embodiment illustrated in other figures in which similar elements may be indicated by reference numbers ending in, and/or containing, the same digits, letters, and/or the like.

Referring to FIG. 8 and FIG. 9, storage system 800 may include one or more clients 802-1, 802-2, and/or 802-3, a data protection node 804, a security host 805, a management host 806 and/or storage network fabric 803.

A first portion of management workflow 900 may involve establishing a trust relationship and implementing one or more policies between data protection node 804 and a management host 806. At operation 947-1, management host 806 may perform one or more operations to establish a trust relationship with data protection node 804. One example of operations may include establishing identification and/or authentication of data protection node 804, management host 806 and/or one or more other components of storage system 800. Another example of operations may include establishing authorization and/or access control between data protection node 804, management host 806 and/or one or more other components of storage system 800. In some embodiments, authorization may establish one or more privileges, whereas access control may establish one or more actions that may be enabled by the one or more privileges. A further example of operations may include securing communications between data protection node 804, management host 806 and/or one or more other components of storage system 800. In some embodiments, communications may include in-band communications, out-of-band communications, side-band communications, communications through separate channels, and/or documenting communications.

At operation 947-2, management host 806 may perform one or more policy-based operations. One example of a policy based operation may include establishing a scope of interactions between data protection node 804, management host 806 and/or one or more other components of storage system 800 as shown by arrow 844A, trust and/or policy information 846, and/or arrow 844B. For example, a policy may require data protection node 804 to only accept management configurations, communications, and/or the like from one or more management hosts 806 and not from a security host 805. Another example of a policy based operation may include establishing one or more default policies for data protection node 804. A further example of a policy based operation may include establishing one or more notification protocols for communications between data protection node 804, management host 806 and/or one or more other components of storage system 800. For example, a policy may require the use of one or more secure communication protocols (e.g., encrypted, authenticated, and/or the like) for communications between data protection node 804, management host 806 and/or one or more other components of storage system 800.

A second portion of management workflow 900 may involve establishing a trust relationship and implementing one or more policies between data protection node 804 and a security host 805. In some embodiments, this may involve operations 947-3 and/or 947-4 which may be implemented in a manner similar to those for operations 947-1 and/or 947-2, respectively, except between data protection node 804 and a security host 805. In some embodiments, a data protection node 804 and a security host 805 may communicate using one or more protocols and/or tools to exchange threat information. Examples may include Structured Threat Information Expression (STIX), Trusted Automated Exchange of Indicator Information (TAXII), and/or Cyber Observable Expression (CYBOX).

A third portion of management workflow 900 may involve establishment of a trust relationship, implementing one or more policies between data protection node 804 and a client 802-1, and/or resource utilization and/or resource management. In some embodiments, this may involve operation 947-5 which may establish a trust relationship in a manner similar to operation 947-1 except using arrow 843-1, trust and/or policy information 845-1, and/or arrow 843B.

At operation 947-6, management host 806 and/or data protection node 804 may perform one or more operations relating to resource utilization by client 802-1. For example, data protection node 804 may monitor usage of storage resources at data protection node 804 by client 802-1. As a further example, if data protection node 804 is configured to periodically store a snapshot of production data at client 802-1, operation 947-6 may determine if client 802-1 fails to delete older snapshots and exceeds a storage allocation for client 802-1.

At operation 947-7, management host 806 and/or data protection node 804 may perform one or more operations relating to resource policies such as establishing default resource policies, establishing retention periods for data replicas by data protection node 804, establishing handling policies (e.g., special handling policies) for backups and/or other protective actions, and/or establishing policies for sharing, data, storage space, communications, and/or the like, between one or more clients 802 and/or one or more data protection nodes 804. Examples of policies relating to data retention periods may include how long to save replicated data, whether older replicated data may be automatically deleted, whether write lock may be used on replicated data and/or the like. Examples of operations relating to sharing may relate to recovering data on a different client 802 because, for example, the original client may no longer be used until it is sanitized, and therefore, data protection node 804 may be authorized to transfer replicated data to a client that was previously unauthorized to receive the replicated data.

At operation 947-8, management host 806 and/or data protection node 804 may perform one or more operations relating to resource management. For example, if client 802-1 exceeds a storage space allocation and/or fails to older snapshots, operation 947-8 may involve notifying client 802-1 that it must reduce its storage utilization, allocating additional storage space to client 802-1, and/or other resource management actions.

Referring to FIG. 9B, a fourth portion of a management workflow for a data protection node may involve operations for installing and/or deinstalling a data protection scheme on a data protection node 804 and/or installing and/or deinstalling a data protection node 804 in a storage system 800. At operation 948-1, data protection node 804 and/or management host 806 may perform an installation operation for a data protection node 804. For example, data protection node 804 may be connected to storage network fabric 803, and an operating system and/or one or more applications for data security may be installed on data protection node 804 to prepare data protection node 804 for online operation in the storage system 800.

At operation 948-2, data protection node 804 may be prepared and configured to engage and/or support one or more clients 802. For example, an amount of storage and/or namespace may be set up for one or more clients 802. At operation 948-3, a management host 806 and/or data protection node 804 may perform one or more operations to establish one or more policies such as default policies, resource policies, security policies, protection policies, attack alert policies, attack detection and/or analysis policies, security notification and/or logging policies, and/or the like which, in some embodiments, may customize one or more policies for a specific storage system 800. In some embodiments, attack alert policies may be based on the presence of a security host 805, and thus, an attack alert policy may configure communications between a data protection node 804 and a security host 805 using a specific protocol, under certain conditions, and/or the like.

At operation 948-4, a management host 806 and/or data protection node 804 may perform one or more operations to activate one or more security features such as data at rest encryption (e.g., data that may be stored at a client 802, a data protection node 804, and/or the like), data in motion encryption (e.g., data that may be in transit between and/or within one or more components such as at a client 802, a data protection node 804, and/or the like), immutability (e.g., write locking, disabling data sanitizing, and/or the like), security notification (e.g., attack alerts) and/or data logging.

At operation 948-5, a management host 806 and/or data protection node 804 may perform one or more operations for resource management. For example, data protection node 804 may be configured to provide additional storage resources that may be allocated to one or more clients 802 and/or applications using one or more clients 802 that may benefit from additional resources due to increasing data usage stemming from efficient operations. In contrast, additional storage resources may be denied and/or deallocated from one or more clients 802 and/or applications using one or more clients 802 that may engage in wasteful practices such as failing to delete older replicas of data.

At operation 948-6, a management host 806 and/or data protection node 804 may configure data protection node 804 to perform one or more data protection operations such as data interactions with one or more clients 802, response to attack alerts, recovery from attack alerts, auto-handling of expired data, threat detection, data analysis, and/or the like.

At operation 948-7, a data protection node 804 may be deinstalled, for example, as part of a lifecycle management scheme for storage system 800. Depending on the circumstances, the workflow 900 may return to operation 948-1 to reinstall a data protection node 804 in a storage system 800 and/or reinstall a data protection scheme on a data protection node 804.

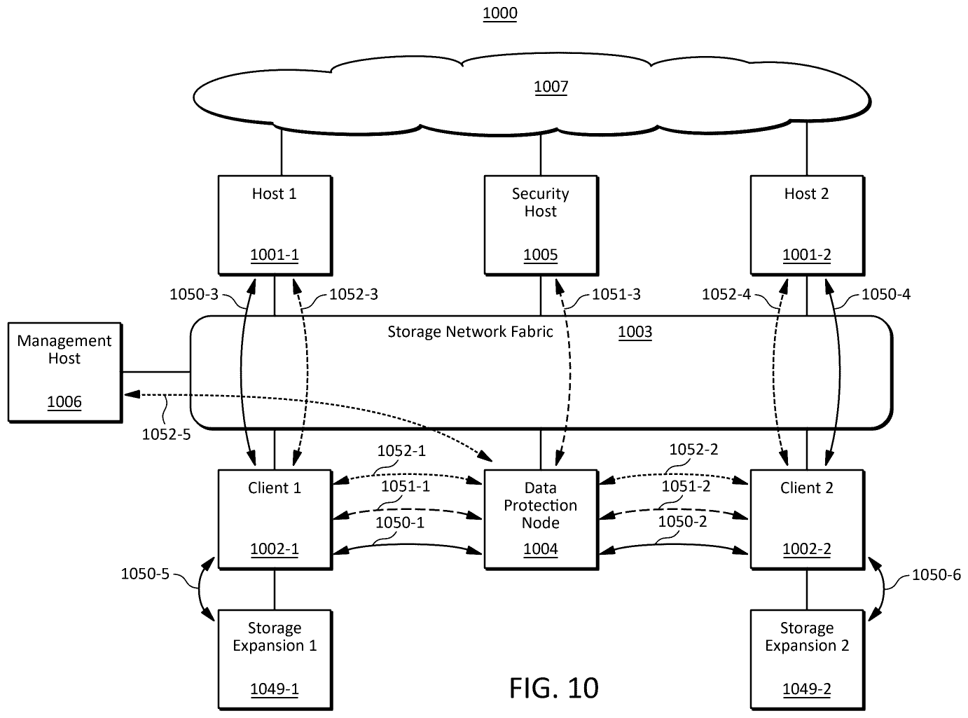

FIG. 10 illustrates an example embodiment of a data protection scheme for a storage system showing some additional possible implementation details for data flow, attack alerts, and/or management flow in accordance with example embodiments of the disclosure. The storage system illustrated in FIG. 10 may include one or more elements that may, in some aspects, be similar to one or more elements in the embodiment illustrated in other figures including FIG. 1 in which similar elements may be indicated by reference numbers ending in, and/or containing, the same digits, letters, and/or the like.

Referring to FIG. 10, storage system may include hosts 1001-1 and 1001-2, security host 1005, management host 1006, clients 1002-1 and 1002-2, and/or data protection node 1004 connected to storage network fabric 1003. Storage expansion 1049-1 and/or 1049-2 may be connected to clients 1002-1 and/or 1002-2, respectively. Any or all of hosts 1001-1, 1001-2, 1005, and/or 1006 may be connected to a network 1007 which may include one or more publicly accessible networks or network of networks such as the internet.

Storage (e.g., production) data flow is indicated by arrows 1050, flow of attack alerts are indicated by arrows 1051, and flow of management information is indicated by arrows 1052.

In some embodiments, transfers of data (e.g., replica data) to and/or from data protection node 1004 as shown by arrows 1050-1 and/or 1050-2 may be performed using one or more first data paths of the storage network fabric 1003 that may be separate and/or different from one or more second data paths used for production data transfer, and therefore, may be mostly or entirely invisible to attackers, hosts 1001-1 and/or 1001-2, and/or users and/or applications running on, and/or using, hosts 1001-1 and/or 1001-2. Depending on the implementation details, this use of a second data path may reduce a security risk for reconnaissance or attack by an adversary. Additionally, or alternatively, this use of a second data path may reduce or eliminate false positive detections and/or alerts. Additionally, or alternatively, transferring data protection information such as copies of replicated data using a data path separate and/or different from a production data path may reduce or eliminate the impact on production data transfers to and/or from storage at clients 1002.

The embodiments illustrated in FIGS. 1 through 10, as well as all of the other embodiments described herein, are example operations and/or components. In some embodiments, some operations and/or components may be omitted and/or other operations and/or components may be included. Moreover, in some embodiments, the temporal and/or spatial order of the operations and/or components may be varied. Although some components and/or operations may be illustrated as individual components, in some embodiments, some components and/or operations shown separately may be integrated into single components and/or operations, and/or some components and/or operations shown as single components and/or operations may be implemented with multiple components and/or operations.

Any of the functionality described herein, including any of the host functionality, device functionally, and/or the like, as well as any of the functionality described with respect to the embodiments illustrated in FIGS. 1-10 may be implemented with hardware, software, firmware, or any combination thereof including, for example, hardware and/or software combinational logic, sequential logic, timers, counters, registers, state machines, volatile memories such DRAM and/or SRAM, nonvolatile memory including flash memory, persistent memory such as cross-gridded nonvolatile memory, memory with bulk resistance change, PCM, and/or the like and/or any combination thereof, complex programmable logic devices (CPLDs), FPGAs, ASICs, CPUs including CISC processors such as x86 processors and/or RISC processors such as ARM processors, GPUs, NPUs, TPUs, and/or the like, executing instructions stored in any type of memory. In some embodiments, one or more components may be implemented as a system-on-chip (SOC), a multi-chip module, one or more chiplets (e.g., integrated circuit (IC) dies) in a package, and/or the like.

Some embodiments disclosed above have been described in the context of various implementation details, but the principles of this disclosure are not limited to these or any other specific details. For example, some functionality has been described as being implemented by certain components, but in other embodiments, the functionality may be distributed between different systems and components in different locations and having various user interfaces. Certain embodiments have been described as having specific processes, operations, etc., but these terms also encompass embodiments in which a specific process, operation, etc. may be implemented with multiple processes, operations, etc., or in which multiple processes, operations, etc. may be integrated into a single process, step, etc. A reference to a component or element may refer to only a portion of the component or element. For example, a reference to a block may refer to the entire block or one or more subblocks. The use of terms such as “first” and “second” in this disclosure and the claims may only be for purposes of distinguishing the elements they modify and may not indicate any spatial or temporal order unless apparent otherwise from context. In some embodiments, a reference to an element may refer to at least a portion of the element, for example, “based on” may refer to “based at least in part on,” and/or the like. A reference to a first element may not imply the existence of a second element. The principles disclosed herein have independent utility and may be embodied individually, and not every embodiment may utilize every principle. However, the principles may also be embodied in various combinations, some of which may amplify the benefits of the individual principles in a synergistic manner. The various details and embodiments described above may be combined to produce additional embodiments according to the inventive principles of this patent disclosure.

Since the inventive principles of this patent disclosure may be modified in arrangement and detail without departing from the inventive concepts, such changes and modifications are considered to fall within the scope of the following claims.

The invention claimed is:

1. An apparatus comprising:
a storage medium;
at least one communication interface configured to receive storage data; and
at least one control circuit configured to perform one or more operations comprising:
transferring, using the at least one communication interface, protection information for the storage data; and
storing, in the storage medium, based on the protection information, the storage data.

2. The apparatus of claim 1, wherein the transferring the protection information comprises receiving, using the at least one communication interface, alert information.

3. The apparatus of claim 1, wherein:
the at least one control circuit is further configured to perform an operation comprising detecting a data protection condition; and
the transferring the protection information comprises sending, using the at least one communication interface, based on the detecting, alert information.

4. The apparatus of claim 1, wherein the at least one control circuit is further configured to perform, based on the protection information, a data protection operation.

5. The apparatus of claim 4, wherein the data protection operation comprises a data lock operation.

6. The apparatus of claim 4, wherein the data protection operation comprises a data hold operation.

7. The apparatus of claim 4, wherein the data protection operation comprises a backup operation.

8. The apparatus of claim 4, wherein the data protection operation is based on a policy.

9. The apparatus of claim 1, wherein the at least one control circuit is further configured to perform, using the storage data, an analysis operation.

10. The apparatus of claim 9, wherein the at least one control circuit is further configured to manage, based on the analysis operation, at least a portion of the storage medium.

11. An apparatus comprising:
a device comprising:
at least one communication interface configured to use a first data path and a second data path; and
a control circuit configured to:
transfer, using the first data path, storage data; and
transfer, using the second data path, protection information for the storage data.

12. The apparatus of claim 11, wherein the protection information comprises a copy of at least a portion of the storage data.

13. The apparatus of claim 11, wherein the protection information comprises alert information.

14. The apparatus of claim 11, wherein the control circuit is further configured to receive, using the second data path, recovery information.

15. A method comprising:
receiving, at a storage network, storage data, wherein the storage network comprises a network fabric;
transferring, to a data protection client, using the network fabric, the storage data;
transferring, to a data protection node, using the network fabric, a copy of at least a portion of the storage data; and
transferring, using the network fabric, alert information for the storage data.

16. The method of claim 15, further comprising performing, by the data protection node, based on the alert information, a data protection operation.

17. The method of claim 15, wherein the alert information is transferred to the data protection node.

18. The method of claim 15, wherein the alert information is transferred from the data protection node.

19. The method of claim 15, further comprising:
detecting, by the data protection node, a data protection condition;
wherein the alert information is generated, based on the data protection condition, by the data protection node.

20. The method of claim 15, wherein:
the storage data is transferred to the data protection client using a first path of the network fabric; and
the copy of the at least a portion of the storage data is transferred using a second path of the network fabric.
